(19) United States
(12) Patent Application Publication
(10) Pub. No.: US 2025/0078316 A1
(43) Pub. Date: Mar. 6, 2025

(54) METHOD FOR UPDATING POSITION OF AREA, SECURITY SYSTEM, AND COMPUTER-READABLE STORAGE MEDIUM

(71) Applicant: BOE Technology Group Co., Ltd., Beijing (CN)

(72) Inventor: Zhen WANG, Beijing (CN)

(21) Appl. No.: 18/293,716

(22) PCT Filed: Feb. 20, 2023
(86) PCT No.: PCT/CN2023/077106

§ 371 Date: Jan. 30, 2024

(30) Foreign Application Priority Data
Apr. 29, 2022 (CN) 202210474787.X
Jun. 30, 2022 (CN) 202210770654.7

(51) Int. Cl. G06T 7/80; G06V 20/40; G06V 20/52

(52) U.S. Cl. CPC G06T 7/80; G06V 20/40; G06V 20/52

(57) ABSTRACT

The present disclosure relates to a method for updating a position of an area, a security system, and a computer-readable storage medium. The method includes: acquiring initial coordinate data of a target area in a video image; tracking a position of the target area in each of subsequent video images according to the initial coordinate data and each of the subsequent video images to obtain a recognition result; when the recognition result includes target coordinate data, determining whether a pose of a camera has changed; and, in response to determining that the pose of the camera has changed, updating the initial coordinate data according to the target coordinate data, to update the position of the target area in each of the subsequent video images.

### CROSS REFERENCE TO RELATED APPLICATION

The present disclosure is a U.S. national phase of PCT Application No. PCT/CN2023/077106 filed on Feb. 20, 2023, which claims priority to Chinese Patent Application No. 202210474787.X filed on Apr. 29, 2022 and claims priority to Chinese Patent Application No. 202210770654.7 filed on Jun. 30, 2022, which are hereby incorporated by reference in their entireties.

### TECHNICAL FIELD

The present disclosure relates to a field of a data processing technology, and in particular, to a method for updating a position of an area, a security system, and a computer-readable storage medium.

### BACKGROUND

With rapid development of a security technology, security systems have been deployed in many key areas. Cameras in the security systems may monitor a security area around the clock, by collecting and recording videos. Moreover, existing security systems also allow users to plan out, through a webpage side, an area A as a restricted area in a video image, and lay special focus on monitoring the restricted area.

### SUMMARY

The present disclosure provides a method for updating a position of an area, a security system, and a computer-readable storage medium, to solve shortcomings of relevant technologies.

According to a first aspect of embodiments of the present disclosure, a method for updating a position of an area is provided. The method includes:
acquiring initial coordinate data of a target area in a video image:
tracking a position of the target area in each of subsequent video images according to the initial coordinate data and each of the subsequent video images to obtain a recognition result;
when the recognition result contains target coordinate data, determining whether a pose of a camera has changed; and
in response to determining that the pose of the camera has changed, updating the initial coordinate data according to the target coordinate data, to update the position of the target area in each of the subsequent video images.

Optionally, acquiring the initial coordinate data of the target area in the video image, includes:
in response to detecting an operation indicating drawing of the target area, acquiring coordinate data of each of triggering positions;
connecting each of the triggering positions in sequence to obtain the target area; and
when a shape of the target area is a rectangle, using the coordinate data of each of the triggering positions as the initial coordinate data of the target area: when the shape of the target area is another shape other than the rectangle, acquiring a minimum bounding rectangle of the another shape, and using coordinate data of each of vertexes of the minimum bounding rectangle as the initial coordinate data of the target area.

Optionally, tracking the position of the target area in each of the subsequent video images according to the initial coordinate data and each of the subsequent video images to obtain the recognition result, includes:
acquiring, based on the initial coordinate data, an image of a target area corresponding to the initial coordinate data in a target video image, to obtain a reference image;
acquiring first tracked images based on the initial coordinate data, where each of the first tracked images refers to an image, containing the target area, in each of video images after the target video image; and
inputting the reference image and one of the first tracked images to a preset area tracking model to obtain the recognition result, where the recognition result includes one or more probability values and coordinate data of at least one candidate area contained in a corresponding video image.

Optionally, the area tracking model includes a siamese network module, a region proposal network module, and a recognition result module:
the siamese network module includes an upper branch network and a lower branch network: the upper branch network and the lower branch network have a same network structure and same parameters: the upper branch network outputs a feature image with a first size, and the lower branch network outputs a feature image with a second size;
the region proposal network module includes a classification branch network and a regression branch network: the classification branch network is configured to distinguish a target and a background according to the feature image with the first size and the feature image with the second size: the regression branch network is configured to adjust a position of each of the at least one candidate area; and
the recognition result module includes a class output unit and a coordinate data output unit: the class output unit is connected to the classification branch network, and configured to output the probability value of each of the at least one candidate area: the coordinate data output unit is connected to the regression branch network, and configured to output the coordinate data of each of the at least one candidate area.

Optionally, the method further includes a step of determining whether the recognition result contains the target coordinate data: where the step specifically includes:
acquiring a maximum value of the one or more probability values of the at least one candidate area; and
when the maximum value exceeds a preset probability threshold, determining a candidate area corresponding to the maximum value as the target area tracked down in the corresponding video image, and obtaining the target coordinate data of the target area. Optionally, the method further includes:
when the maximum value is less than the preset probability threshold, determining that the target area is not tracked down in each of the corresponding video image.

Optionally, determining that the target area is not tracked down in the corresponding video image, includes:
determining whether a target area in the first video image is located at the vertexes of the first video image, where the first video image refers to a video image before the video image in which the target area is not tracked down;
when the target area is located at the vertexes of the first video image, acquiring at least one target pixel, located within the first video image, in the target area;
acquiring a first distance between the at least one target pixel and the boundary of the first video image; and
when the first distance is less than a preset distance threshold, determining that the target area being not tracked down in the corresponding video image is a type that the target area has been offset out of the video image.

Optionally, determining that the target area is not tracked down in the corresponding video image, includes:
determining whether a target area in a first video image is located at a boundary of the first video image, where the first video image refers to a video image before a video image in which the target area is not tracked down;
when the target area has a vertex located at the boundary of the first video image, acquiring a second distance between a vertex, away from the boundary, in the target area and the boundary; and
when the second distance is less than a preset distance threshold, determining that the target area being not tracked down in the corresponding video image is a type that the target area has been offset out of the video image.

Optionally, when the target area being not tracked down is that the area tracking model is abnormal and the target area is within a first video image, the method further includes:
reducing a tracking matching threshold according to a preset step size, and performing the step of tracking the position of the target area in each of the subsequent video images according to the initial coordinate data and each of the subsequent video images to obtain the recognition result, until determining that the target area is tracked down in the corresponding video image or the tracking matching threshold is equal to a first probability threshold, where the first probability threshold refers to a minimum value of the tracking matching threshold.

Optionally, when the target area being not tracked down is that the area tracking model is abnormal and the target area is within a first video image, the method further includes:
generating a plurality of second tracked images by taking each of vertexes of a first tracked image corresponding to the corresponding video image as a center and by taking a length and width of the first tracked image as a reference, and performing a step of inputting the reference image and one of the second tracked images to the preset area tracking model. Optionally, the method further includes:
acquiring a distance between preset points of the target area in two adjacent video images;
when the distance between the preset points is less than a center distance threshold, performing an update with newly recognized coordinate data of the target area; and
when the distance between the preset points exceeds the center distance threshold, for a video image in which the target area is not tracked down, maintaining a target area of a previous video image or adopting a constructed area, where the constructed area refers to a weighted value of coordinate data of the target area in a plurality of video images before the video image in which the target area is not tracked down.

Optionally, determining whether the pose of the camera has changed, includes:
acquiring an angle change of the camera; and
when the angle change meets a preset condition, determining that the pose of the camera has changed.

Optionally, determining whether the pose of the camera has changed, includes:
acquiring distances between a same pixel in the target area in two adjacent video images; and
when at least one of the distances between the respective pixels exceeds a pixel distance threshold, determining that the pose of the camera has changed.

Optionally, determining whether the pose of the camera has changed, includes:
acquiring a distance between preset points of the target area in two adjacent video images; and
when the distance between the preset points exceeds a center threshold, determining that the pose of the camera has changed.

Optionally, updating the initial coordinate data according to the target coordinate data, includes:
when a shape of the target area is a rectangle, updating the initial coordinate data to the target coordinate data: or
when the shape of the target area is another shape other than the rectangle, acquiring relative position data of a preset target area relative to a minimum bounding rectangle; calculating target recovery data of the target area according to the target coordinate data and the relative position data; and updating the initial coordinate data to the target recovery data.

According to a second aspect of embodiments of the present disclosure, a security system is provided The system includes an area configuration module, an area tracking module, an update determination module, and a coordinate return module:
the area configuration module is configured to acquire initial coordinate data of a target area in a video image, and send the initial coordinate data to the area tracking module;
the area tracking module is configured to track a position of the target area in each of subsequent video images according to the initial coordinate data and each of the subsequent video images to obtain a recognition result, and when the recognition result contains target coordinate data, send the target coordinate data to the update determination module;
the update determination module is configured to determine whether a pose of a camera has changed, and in response to determining that the pose of the camera has changed, send the target coordinate data to the coordinate return module; and in
the coordinate return module is configured to return the target coordinate data to the area configuration module, so that the area configuration module updates the initial coordinate data according to the target coordinate data, to update the position of the target area in each of the subsequent video images.

Optionally, the area configuration module includes:
a coordinate data acquisition unit, configured to: in response to detecting an operation indicating drawing of the target area, acquire coordinate data of each of triggering positions;
a target area acquisition unit, configured to connect each of the triggering positions in sequence to obtain the target area; and
an initial coordinate acquisition unit, configured to: when a shape of the target area is a rectangle, use the coordinate data of each of the triggering positions as the initial coordinate data of the target area: when the shape of the target area is another shape other than the rectangle, acquire a minimum bounding rectangle of the another shape, and use coordinate data of each of vertexes of the minimum bounding rectangle as the initial coordinate data of the target area.

Optionally, the area tracking module being configured to track the position of the target area in each of the subsequent video images according to the initial coordinate data and each of the subsequent video images to obtain the recognition result, includes:
based on the initial coordinate data, acquiring an image of a target area corresponding to the initial coordinate data in a target video image, to obtain a reference image;
based on the initial coordinate data, acquiring an image, containing the target area, in each of video images after the target video image, to obtain a first tracked image corresponding to each of the video images; and
inputting the reference image and one of the first tracked images to a preset area tracking model to obtain the recognition result output by the area tracking model, where the recognition result includes one or more probability values and coordinate data of at least one candidate area contained in a corresponding video image.

Optionally, the area tracking module being configured to, when the recognition result contains the target coordinate data, send the target coordinate data to the update determination module, includes:
acquiring a maximum value of the one or more probability values of the at least one candidate area;
when the maximum value exceeds a preset probability threshold, determining a candidate area corresponding to the maximum value as the target area tracked down in the corresponding video image, and obtaining the target coordinate data of the target area; and
sending the target coordinate data of the target area to the update determination module.

Optionally, the area tracking module is further configured to:
when the maximum value is less than the preset probability threshold, determine that the target area is not tracked down in the corresponding video image.

Optionally, the area tracking module being configured to determine that the target area is not tracked down in the corresponding video image, includes:
determining whether a target area in a first video image is located at a boundary of the first video image, where the first video image refers to a video image before a video image in which the target area is not tracked down;
when the target area has a vertex located at the boundary of the first video image, acquiring a second distance between a vertex, away from the boundary, in the target area and the boundary; and
when the second distance is less than a preset distance threshold, determining that the target area being not tracked down in the corresponding video image is a type that the target area has been offset out of the video image.

Optionally, when the target area being not tracked down is that the area tracking model is abnormal and the target area is within a first video image, after the area tracking module is configured to determine that the target area is not tracked down in each of the video images, the area tracking module is further configured to:
reduce a tracking matching threshold according to a preset step size, and perform the step of tracking the position of the target area in each of the subsequent video images according to the initial coordinate data and each of the subsequent video images to obtain the recognition result, until determining that the target area is tracked down in the corresponding video image or the tracking matching threshold is equal to a first probability threshold, where the first probability threshold refers to a minimum value of the tracking matching threshold.

Optionally, when the target area being not tracked down is that the area tracking model is abnormal and the target area is within a first video image, after the area tracking module is configured to determine that the target area is not tracked down in each of the video images, the area tracking module is further configured to:
generate a plurality of second tracked images by taking each of vertexes of a first tracked image corresponding to the corresponding video image as a center and by taking a length and width of the first tracked image as a reference, and perform a step of inputting the reference image and one of the second tracked images to the preset area tracking model.

Optionally, the area tracking module is further configured to:
acquire a distance between preset points of the target area in two adjacent video images;
when the distance between the preset points is less than a center distance threshold, perform an update with newly recognized coordinate data of the target area; and
when the distance between the preset points exceeds the center distance threshold, for a video image in which the target area is not tracked down, maintain a target area of a previous video image or adopting a constructed area, where the constructed area refers to a weighted value of coordinate data of the target area in a plurality of video images before the video image in which the target area is not tracked down.

Optionally, the update determination module being configured to determine whether the pose of the camera has changed, includes:
acquiring an angle change of the camera; and
when the angle change meets a preset condition, determining that the pose of the camera has changed.

Optionally, the update determination module being configured to determine whether the pose of the camera has changed, includes:
acquiring distances between a same pixel in the target area in two adjacent video images; and
when at least one of the distances between the respective pixels exceeds a pixel distance threshold, determining that the pose of the camera has changed.

Optionally, the update determination module being configured to determine whether the pose of the camera has changed, includes:
acquiring a distance between preset points of the target area in two adjacent video images; and
when the distance between the preset points exceeds a center threshold, determining that the pose of the camera has changed.

Optionally, the area configuration module includes:
a first configuration module, configured to: when a shape of the target area is a rectangle, directly update the initial coordinate data according to the target coordinate data: or a second configuration module, configured to: when the shape of the target area is another shape other than the rectangle, acquire relative position data of a preset target area relative to a minimum bounding rectangle: calculate target recovery data of the target area according to the target coordinate data and the relative position data; and update the initial coordinate data to the target recovery data.

According to a third aspect of embodiments of the present disclosure, a security system is provided. The security system includes at least one camera, at least one configuration terminal, and a server: where the camera is configured to collect an image and send the image to the server: the configuration terminal is configured to acquire initial coordinate data of a target area and send the initial coordinate data to the server: the server includes:
a processor; and a memory configured to store a computer program executable by the processor;
where the processor is configured to execute the computer program stored in the memory, to implement the method as described in the first aspect.

According to a fourth aspect of embodiments of the present disclosure, a computer-readable storage medium is provided. An executable computer program in the storage medium, when executed by a processor, can implement the method as described in the first aspect.

The technical solutions provided by the embodiments of the present disclosure may include the following beneficial effects.

As known from the above embodiments, the solutions provided by the present disclosure may: acquire initial coordinate data of a target area in a video image: then, track a position of the target area in each of subsequent video images according to the initial coordinate data and the subsequent video images to obtain a recognition result: then, when the recognition result contains target coordinate data, determine whether a pose of a camera has changed: finally, in response to determining that the pose of the camera has changed, update the initial coordinate data according to the target coordinate data, to update the position of the target area in each of the subsequent video images. Thus, in the embodiments, the target areas in the video images remain in position unchanged when the pose of the camera has not changed, and the coordinate data of the target areas will be updated after the pose of the camera has changed to the target coordinate data, that is, the positions of the target areas are synchronously updated after the camera moves and/or rotates, so that the target areas will not be mispositioned with the movement and/or rotation of the camera, and then there will be no problem of misrecognition and false alerts during the subsequent process of recognition of objects in the target areas, which is beneficial to improving the recognition efficiency, and further improving the usage experience.

It should be understood that the above general descriptions and the following detailed descriptions are merely for exemplary and explanatory purposes, and cannot limit the present disclosure.

### BRIEF DESCRIPTION OF DRAWINGS

Accompanying drawings herein, which are incorporated in a specification and form a portion of the specification, show embodiments conforming to the present disclosure and are used to explain principles of the present disclosure together with the specification.

FIG. 1 is a flowchart of a method for updating a position of an area shown according to an exemplary embodiment.

FIG. 2 is a schematic diagram of a target area being of a polygonal shape shown according to an exemplary embodiment.

FIG. 3 is a schematic diagram of another target area being of a circle shape shown according to an exemplary embodiment.

FIG. 4 is a schematic effect diagram of configuration of a target area shown according to an exemplary embodiment.

FIG. 5 is a flowchart of acquiring a recognition result shown according to an exemplary embodiment.

FIG. 6 is a schematic structure diagram of an area tracking model shown according to an exemplary embodiment.

FIG. 7 is a flowchart of acquiring target coordinate data shown according to an exemplary embodiment.

FIG. 8 is a flowchart of a tracking stabilization mechanism shown according to an exemplary embodiment.

FIG. 9 is a flowchart of another tracking stabilization mechanism shown according to an exemplary embodiment.

FIG. 10 is a schematic diagram of a target area at an edge of a current video image shown according to an exemplary embodiment.

FIG. 11 is a flowchart of acquiring a target area offset out of a video image shown according to an exemplary embodiment.

FIG. 12 is another flowchart of acquiring a target area offset out of a video image shown according to an exemplary embodiment.

FIG. 13 is a flowchart of acquiring target coordinate data of a target area shown according to an exemplary embodiment.

FIG. 14 is a workflow diagram of a security system shown according to an exemplary embodiment.

FIG. 15 is another workflow diagram of a security system shown according to an exemplary embodiment.

FIG. 16 is another workflow diagram of a security system shown according to an exemplary embodiment.

FIG. 17 is a schematic effect diagram of acquiring a target area according to an exemplary embodiment.

FIG. 18 is a block diagram of a security system shown according to an exemplary embodiment.

FIG. 19 is a block diagram of a server shown according to an exemplary embodiment.

### DETAILED DESCRIPTION

Exemplary embodiments will be described in detail herein, examples of which are represented in the accompanying drawings. When the following description relates to the accompanying drawings, unless specified otherwise, same numerals in different drawings represent same or similar elements. Embodiments exemplary described below do not represent all embodiments consistent with the present disclosure. Rather, these embodiments are merely apparatus examples consistent with some aspects of the present disclosure as detailed in the appended claims. It is to be noted that, without conflict, features in embodiments and implementations described below may be combined with each other.

In a practical application, when setting a target area, such as a restricted area, etc., in a video image, because an object in the target area may move out of the above target area when the object moves, a user is to adjust an orientation of a camera to monitor security situations of different areas. When the orientation of the camera is moved and/or rotated, the above target area will change synchronously therewith, that is, a coverage range of the target area changes from an area A to an area B. At this time, the camera may recognize the object in the area B and give an alert. However, the area B is not the target area A expected to be monitored, thus resulting in a false alert, and reducing usage experience.

To solve the above technical problems, embodiments of the present disclosure provide a method for updating a position of an area, which may be applied to a security system. In an example, the security system includes at least one camera and at least one configuration terminal. In another example, the security system includes at least one camera, a server, and at least one configuration terminal. Where, the configuration terminal may, as a web configuration side, configure video images accordingly, such as set a target area (e.g., a restricted area), to prevent the object from entering the target area. The server may communicate with any camera in the security system. Communication manners include a wired manner or a wireless manner. Examples of the wireless manner include but are not limited to a Bluetooth manner, a WiFi manner, a Zigbee manner, etc. The server may acquire the video images (pictures or video images) collected by the camera via the above communication manners and distribute the video images to each configuration terminal for display. Certainly, in a case that the cameras have sufficient processing resources, the cameras may also substitute for the server to distribute the collected images to each configuration terminal for display. That is, in the present disclosure, both the cameras and the server may perform a method for updating a position of an area, which may be set according to specific scenarios. In subsequent embodiments, the cameras only collect images and upload the images to the server, and the server performs a method for updating a position of an area, which is taken as an example to describe the solution of each embodiment.

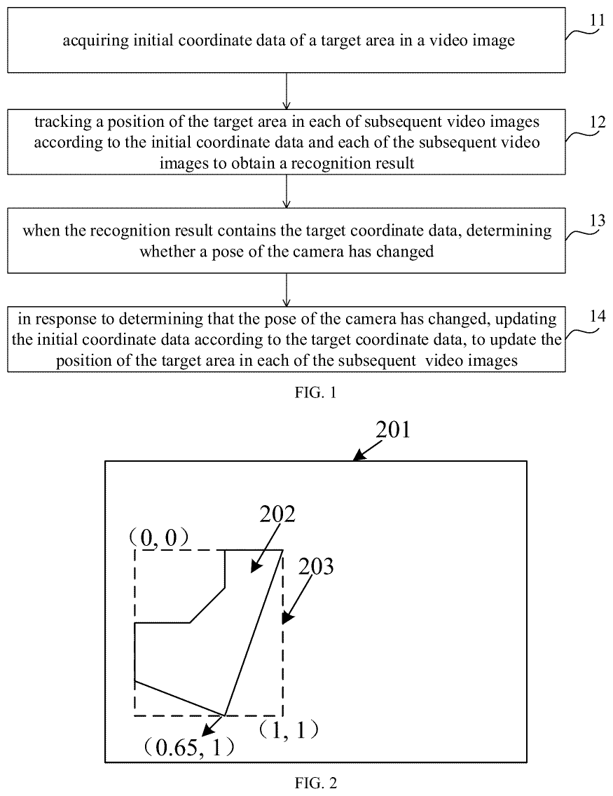

FIG. 1 is a flowchart of a method for updating a position of an area shown according to an exemplary embodiment. As seen in FIG. 1, the method for updating a position of an area includes step 11 to step 14.

At step 11, initial coordinate data of a target area in a video image is acquired.

In this embodiment, the configuration terminal may display a video image collected by a camera, and the user may select at least one background in the video image as a target area. The target area is an area corresponding to a portion of the video image displayed by the configuration terminal, and is used to determine a recognition scope to determine whether an object enters or leaves the target area. For example, the target area is a restricted area that is used to determine an area where the object is prohibited from entering. The security system may give an alert when detecting that an object enters the area.

In this embodiment, a shape of the above target area may be a rectangle or another shape other than the rectangle.

In an embodiment, when the target area is rectangular (e.g., the user selects a rectangle component), the configuration terminal may acquire initial coordinate data of the target area, including that: when detecting an operation indicating drawing of the target area, the configuration terminal may acquire coordinate data of triggering positions in a current video image. The coordinate data of the above triggering positions may include triggering positions for multiple single triggers detected within a preset duration, which may be applicable to a discrete touch control operation scenario. For example, coordinate data of a total of 4 points, a point A, a point B, a point C, and a point D, is used as the coordinate data of the triggering positions. The coordinate data of the above triggering positions may include coordinate data of each of positions that is collected according to a set period and are between a first press position and a last pop-up position by the user detected by the configuration terminal, which may be applicable to a continuous touch control operation scenario. For example, when pressing at the point A, passing through the point B and the point C, and finally popping up at the point D, the coordinate data of the points A. B. C, and D collected by the configuration terminal according to the set period is used as the coordinate data of the triggering positions. When detecting an operation indicating saving of the target area, the configuration terminal may acquire coordinate data of all triggering positions to obtain the initial coordinate data.

In an embodiment, when the shape of the target area is another shape other than the rectangle (e.g., the user selects other shape components or does not select a component), the configuration terminal may acquire initial coordinate data of the target area, including that: when detecting an operation indicating drawing of the target area, the configuration terminal may acquire coordinate data of each of the triggering positions in the current video image, and connect each of the triggering positions in sequence to form an enclosed candidate area. When the shape of the candidate area is rectangular, the configuration terminal may use coordinate data of vertexes of the candidate area as the initial coordinate data of the target area. When the shape of the candidate area is another shape other than the rectangle, the configuration terminal acquires a minimum bounding rectangle of the another shape, and uses coordinate data of each of vertexes of the minimum bounding rectangle as the initial coordinate data of the target area.

It is to be noted that after using the coordinate data of the minimum bounding rectangle as the initial coordinate data of the target area, it is equivalent to replacing the image in the target area with an image in an area where the minimum bounding rectangle is located, as data that is to be processed when tracking. To ensure that the target area can be accurately restored after tracking, in this embodiment, during or after the process of determining the initial coordinate data of the target area, relative coordinate data of the target area relative to the minimum bounding rectangle may also be acquired. The target area may be restored according to the updated position of the minimum bounding rectangle, which achieves an effect of updating the position of the target area.

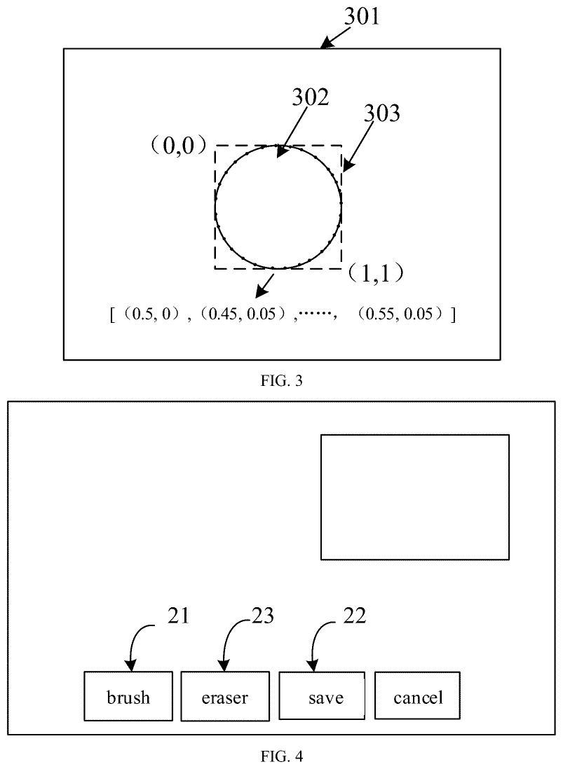

As seen in FIG. 2, the target area 202 in the current video image 201 has the minimum bounding rectangle 203. Assuming that the minimum bounding rectangle 203 has an upper left corner coordinate of (0, 0) and a lower right corner coordinate of (1, 1), then the configuration terminal may calculate the relative coordinate data of each of points in the target area relative to the minimum bounding rectangle, for example, the relative coordinate of the bottommost point is (0.65, 1). As seen in FIG. 3, when the target area 302 in the current video image 301 is a circle shape/oval shape or a continuous irregular shape drawn manually, the configuration terminal may, after finding the minimum bounding rectangle 303, calculate the relative coordinate data of all discrete points relative to the minimum bounding rectangle 303 of the target area 302. For example, a set of discrete points is [(0.5, 0), (0.45, 0.05) . . . (0.55, 0.05)].

In addition, during the process of acquiring the initial coordinate data, when detecting an operation indicating removing of the target area, the configuration terminal may delete coordinate data of all triggering positions or coordinate data of a latest triggering position. Thus, the target area is allowed to be manually set in this embodiment, which may ensure accuracy of the target area and improve fun and practicality of human-machine interaction.

In a practical application, functional components are usually set in a configuration interface, and when detecting an operation of selecting a functional component in the video image, the configuration terminal in the security system may display a configuration interface corresponding to the above functional component, where, the configuration interface may include a brush component and a save component. As seen in FIG. 4, the configuration interface may include a brush component 21 and a save component 23.

When detecting an operation of selecting the brush component, the configuration terminal may acquire a triggering position of the brush component in the video image and use the triggering position as a vertex of the target area, and may acquire the coordinate data of the triggering position at this time.

The user may use the brush component to repeat operations in the video image (i.e., multiple click operations), and the configuration terminal may detect multiple triggering positions and the coordinate data of each of the triggering positions. In a practical application, when detecting three or more triggering positions, the configuration terminal may connect these triggering positions in sequence to form an enclosed candidate area, and display the enclosed candidate area in the video image for the user to view.

In an embodiment, when detecting an operation of selecting the save component, the configuration terminal displays a preset prompt message in the video image to prompt that the target area has been configured completely. In an example, the configuration terminal may display a preset prompt message of “area being configured completely” at an upper left corner of the video image, and adopt an animation effect that the preset prompt message fades out within three seconds to prompt the user, so that the user determines that the target area has been configured completely, improving the usage experience. Then, the configuration terminal may use a center of the target area as a reference, to record the coordinate data of each of the vertexes of the target area in clockwise order, and the coordinate data of all the vertices in the target area may constitute initial coordinate data. Eventually, the configuration terminal may upload the above initial coordinate data to the server. In this way, the server may acquire the initial coordinate data of the target area in the video image.

In another embodiment, the server may also acquire the target coordinate data of the target area after the camera moves and/or rotates and use the target coordinate data to update the above initial coordinate data, where the solution of acquiring the target coordinate data will be described in subsequent embodiments and not described here. The camera may move and/or rotate in three dimensions, and by using a fulcrum of the camera as a reference, the camera may rotate up, down, left, right, clockwise along an optical axis, and counterclockwise along the optical axis. Of course, the camera may also move and/or rotate in seven dimensions, that is, in addition to moving and/or rotating in three dimensions by using the fulcrum of the camera as the reference, the camera may also move and/or rotate, with a fixed end of an object (e.g., a column) to which the camera is attached, in four dimensions, such as a front-rear dimension (causing the camera to move along an X axis) of the fixed end, a left-right dimension (causing the camera to move along a Y axis) of the fixed end, an up-down dimension (causing the camera to move along a Z axis) of the fixed end, and counterclockwise or clockwise rotation around the Z axis of the column (causing the camera to rotate left and right), etc. It can be understood that no matter in which dimension the camera moves and/or rotates, the target coordinate data is acquired by using the images collected by the camera as the reference, not affecting implementation of the solution of the present disclosure.

At step 12, a position of the target area in each of subsequent video images is tracked according to the initial coordinate data and each of the subsequent video images to obtain a recognition result.

In this embodiment, the configuration terminal may display video images collected by at least one camera. For example, each camera uploads the collected video images to the server. The server may acquire the configuration information and push the above video images to the configuration terminal specified in the above configuration information. In other words, the server may determine each of the video images displayed by the configuration terminal.

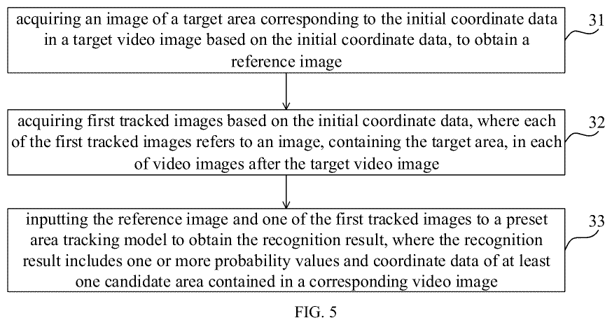

Then, the server may track a position of the target area in each of the video images according to the initial coordinate data and each of the video images to obtain a recognition result, which includes step 31 to step 33 as seen in FIG. 5.

At step 31, the server may acquire an image of a target area corresponding to the initial coordinate data in a target video image based on the initial coordinate data, to obtain a reference image where the target video image refers to a first frame of video image obtained after acquiring the initial coordinate data. For example, after the configuration terminal uploads the updated initial coordinate data to the server, the server will pull a stream after receiving the above initial coordinate data, and then the pulled first frame of video image is the target video image. After obtaining the target video image, the server may find, in the target video image, each of vertexes corresponding to the initial coordinate data, and then connect each of the vertexes (in a clockwise or counterclockwise manner) in sequence to obtain an enclosed area. An image in the enclosed area is the reference image.

At step 32, the server may acquire first tracked images based on the initial coordinate data, where each of the first tracked images is an image, containing the target area, in each of video images after the target video image. Assuming that the target video image is numbered as 1, then each of the video images is numbered as n, n=2, 3, 4, . . . , i.e., n is an integer greater than or equal to 2. The server may determine areas, corresponding to the initial coordinate data, in the video images according to the solution of step 31. It can be understood that positions of the areas corresponding to the initial coordinate data at this time may be same as or may be different from the position of the target area in the target video image, so the solution of the present disclosure is to predict the position of the target area in each of the video images after the target video image. In this step, the server may generate a larger area containing an area corresponding to the above initial coordinate data. For example, when the area corresponding to the initial coordinate data is a rectangle, a length and a width of the area may be doubled to obtain a larger rectangle with area four times previous area. The server may then use an image in the above larger area as a first tracked image. By repeating the above step, the server may obtain the first tracked image corresponding to each of the video images after the target video image.

At step 33, the server may input the reference image and one of the first tracked images to a preset area tracking model to obtain the recognition result, where the recognition result includes one or more probability values and coordinate data of at least one candidate area in a corresponding video image.

In this step, the server may store the preset area tracking model, which has been trained in advance completely and may track the target area. In this example, the area tracking model includes a siamese network module, a region proposal network (RPN) module, and a recognition result module.

The siamese network module includes an upper branch network and a lower branch network. The upper branch network and the lower branch network have a same network structure and same parameters, and the network structures of the upper branch network and the lower branch network do not include an output layer, so a difference between the upper branch network and the lower branch network is that the upper branch network outputs a feature image with a first size, and the lower branch network outputs a feature image with a second size. The region proposal network module includes a classification branch network and a regression branch network. The classification branch network is connected to the upper branch network and the lower branch network respectively, and configured to distinguish the target and the background according to the feature image with the first size and the feature image with the second size; and the regression branch network is connected to the upper branch network and the lower branch network respectively, and configured to adjust a position of each of the at least one candidate area. The recognition result module includes a class output unit and a coordinate data output unit: the class output unit is connected to the classification branch network and is configured to output the probability value of each of the at least one candidate area: the coordinate data output unit is connected to the regression branch network and is configured to output the coordinate data of each of the at least one candidate area. In an example, the above area tracking model may adopt an area tracking model based on depth features, including but not limited to SiamFC, siamRPN, DaSiamRPN, siamRPN++, etc. In this example, the above area tracking model may adopt the siamRPN++ algorithm.

As seen in FIG. 6, a left portion of the area tracking model is a siamese network structure 41, and the upper branch network and the lower branch network have the identical network structure and parameters. In addition, input data of the upper branch network is the reference image, and an object to be tracked is determined according to the reference image, in other words, the feature data of the reference image is acquired as reference feature data. The input data of the lower branch network is a first tracked image, or, a video image to be detected. Obviously, the area of the first tracked image is larger than the area of the reference image, that is, a search area of the first tracked image is larger than a search area of the reference image, to ensure that the offset target area is still within the search area. The two branches of the siamese network structure 41 acquire feature vectors of the reference image and the first tracked image respectively, and obtain a similarity between two feature vectors; the greater the similarity is, the more likely the first tracked image and the reference image are of the same classification.

Continuing to see FIG. 6, a middle portion of the area tracking model is the region proposal network 42, and the region proposal network 42 consists of two branches. The upper branch is the classification branch used to distinguish the target and the background (e.g., the content in the target area in subsequent embodiments), and the feature data obtained after the reference image and the first tracked image go through the siamese network then goes through a convolutional layer to become 2 k*256 channels: where k is the number of anchor boxes, and 2 k refers to being divided into two classes. The lower branch is the regression branch for fine-tuning candidate areas, and is a bounding box regression branch with four quantities [x, y, w, h], so the number of channels is 4 k*256, where x, y, w; and h refer to an abscissa offset, an ordinate offset, a width offset, and a height offset of the target area, respectively. In a practical application, the lower branch may also output coordinate data on the basis of the above coordinate offset data, which is not limited herein.

Continuing to see FIG. 6, a right portion of the area tracking model is the tracked target area.

It is to be noted that a conception of the area tracking model in the present disclosure is that: by processing a video image sequence collected by the camera, positions, in each of video images, of an object (i.e., a parking space, a road, etc., within the restricted area) in the target area (i.e., the restricted area) in the target video image is calculated: then, according to feature values associated with the object, the same object in the video image sequence is associated to obtain a motion parameter of the object in each of the video images and a correspondence relationship of the object between adjacent frames, so as to obtain a motion trajectory of the object. In other words, the conception of the area tracking model in the present disclosure is to find the object present in the reference image from the first tracked images, and the areas where the found object is located are the target areas in the first tracked images. In other words, in the present disclosure, the tracking target in each of the video images is found, based on an immovable object in a physical world corresponding to a target area as a tracking target, and combined with a principle that imaging of the above tracking target in the camera remains basically unchanged, and the target areas corresponding to the tracking target are determined, that is, the target areas are found in the first tracked images. It is to be noted that when a target area contains partial movable objects and immovable objects, considering that a (area) proportion of the immovable objects in the target area exceeds a preset proportion threshold (such as 60%), a subsequent preset probability threshold may be adjusted according to the proportion of the movable objects: for example, the larger the proportion corresponding to the movable objects is, the smaller the preset probability threshold is, so as to select matching target coordinate data.

In this embodiment, the server may call the above preset area tracking model, input the reference image and the first tracked images to the above area tracking model, that is, input the reference image to the upper branch of the siamese network and input the first tracked images to the lower branch of the siamese network. Then the area tracking model may process the above reference image and first tracked images, and output a recognition result. It can be understood that the above recognition result includes the one or more probability values and coordinate data (i.e., the coordinate data of each area) of at least one candidate area in the corresponding video image. In this way, the server may obtain the above recognition result.

At step 13, when the recognition result contains the target coordinate data, whether a pose of the camera has changed is determined.

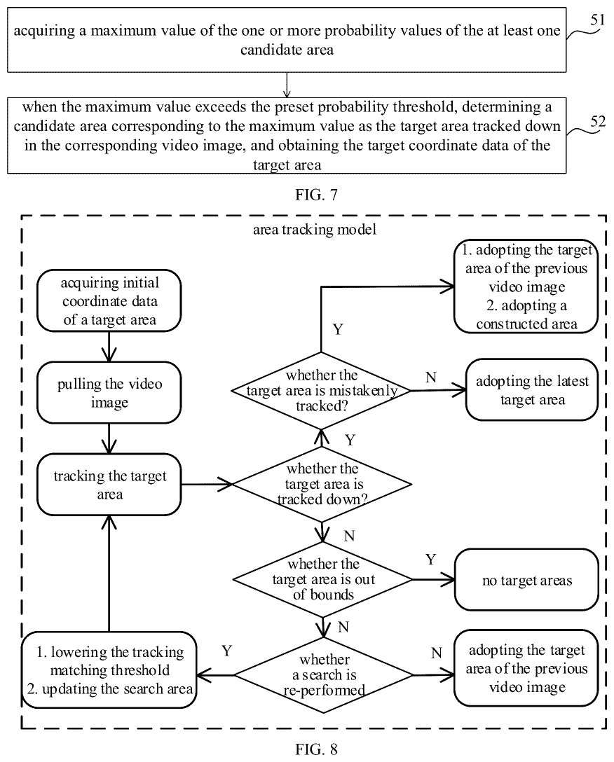

In this embodiment, after obtaining the recognition result, the server may determine whether the above recognition result contains the target coordinate data, as seen in FIG. 7, including step 51 and step 52.

At step 51, the server may acquire a maximum value of the one or more probability values of the at least one candidate area in the above recognition result. For example, the server may obtain the maximum value by directly sorting the one or more probability values of the above at least one candidate area. The server may store a preset probability threshold, that ranges from 0.6˜1.0. The server may then compare the maximum value with the above preset probability threshold, to obtain a size relationship between the maximum value and the preset probability threshold.

At step 52, when the maximum value exceeds the preset probability threshold, the server may determine a candidate area corresponding to the maximum value as the target area tracked down in the corresponding video image, and obtain the target coordinate data of the target area. When the maximum value is less than the above preset probability threshold, the server may determine that the target area is not tracked down in each of the video images. In this step, whether the target area is tracked down is determined by selecting the maximum value and the preset probability threshold, which may improve the accuracy of the result.

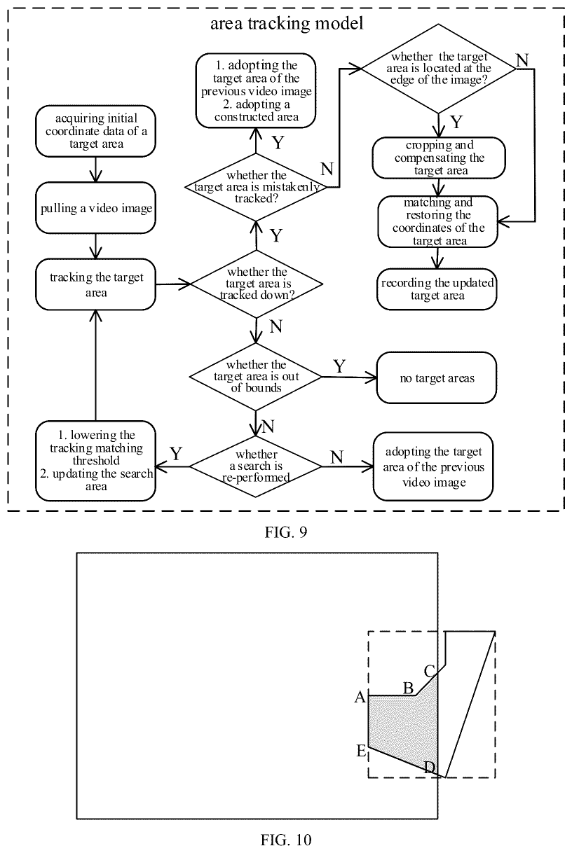

Considering that it may not be able to ensure that the area tracking model can track the target area accurately in all situations, for example, when there are abnormal situations, such as severely blurred video images or flickering screens, the area tracking model may fail. It is considered that there may be two situations that the target area is not tracked down in each of the video images: first, the area tracking model is normal and the target area has been offset out of the range of the video image: second, the target area is within the range of the video image and the area tracking model is abnormal. For the above problems, the embodiments of the present disclosure also provide a tracking stability mechanism, to ensure that the target area can be tracked normally in the situation of an abnormal area tracking model. As seen in FIG. 8 and FIG. 9, the server tracks the target area and determines whether the target area is tracked down.

After determining that the target area is tracked down, whether the above target area is mistakenly/falsely tracked is determined, and if determining that the target area is not mistakenly tracked, the server may determine that the above target area is accurate. At this point, the server may determine whether the target area is located at an edge of the current video image: if the target area is not at the edge of the current video image, adopt the target coordinate data of the latest target area: if the target area is at the edge of the current video image, crop and compensate the target area, that is, acquire coordinate data of a portion, located within the current video image, of the target area. As seen in FIG. 10, the server may crop and compensate the target area according to the boundary of the current video image, and determine coordinate data of a polygon ABCDE as the target coordinate data. If determining that the target area is mistakenly tracked, the server may determine that the target area of the current video image (that is, the video image in which the target area is not tracked down) maintains a target area in a previous video image, or adopts a constructed area where, the constructed area refers to a weighted value of coordinate data of the target areas in a plurality of video images before the video image in which the target area is not tracked down.

After determining that the target area is not tracked down, whether the above target area is out of bounds is determined. The target area being out of bounds includes the target area being out of bounds from vertexes of the first video image or being out of bounds from the boundary of the first video image. If determining that the target area is out of bounds, that there is no target area in the video image is determined. If determining that the target area is not out of bounds, whether a search is to be re-performed is determined: if the search is not to be re-performed, the target area of the previous video image is maintained; and if the search is to be re-performed, a tracking matching threshold is lowered or the first tracked images are updated to re-perform the search.

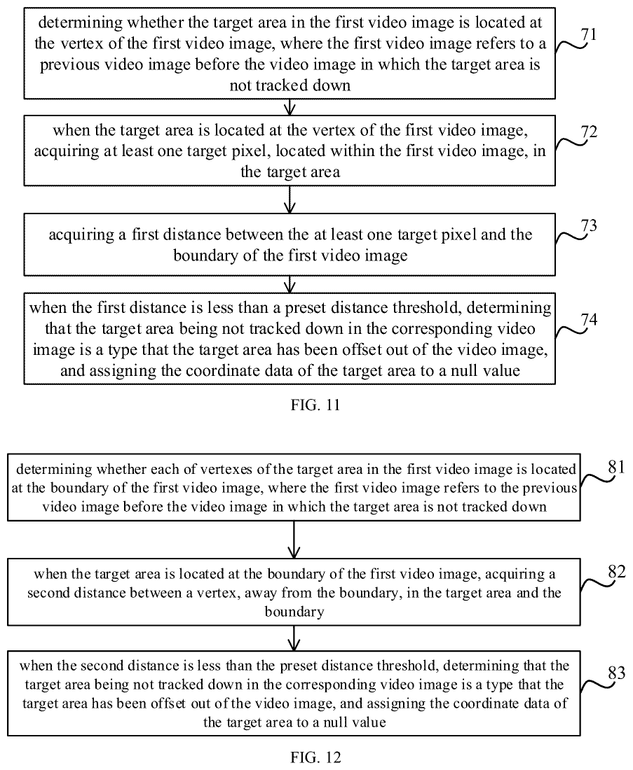

In an embodiment, in the first situation, the server may determine whether the target area is out of bounds (from the vertexes of the first video image), as seen in FIG. 11, including step 71 to step 74.

At step 71, the server may determine whether the target area in the first video image is located at the vertex of the first video image, where the first video image refers to a previous video image before the video image in which the target area is not tracked down. For example, the server may acquire each of vertexes of the target area in the first video image. It can be understood that when a portion of the target area is about to be offset out of the first video image, the target area may be located in an upper left corner/upper right corner/lower left corner/lower right corner of the first video image, and at this point at least one vertex of the target area coincides with one or more vertexes of the first video image. Therefore, the server may determine whether the coordinate data of the upper left vertex of the target area is [0, 0], whether the abscissa x of the lower left vertex of the target area is 0, whether the ordinate y of the upper right vertex of the target area is 0), whether the abscissa of the lower right vertex of the target area is the maximum value of the abscissa, and whether the ordinate of the lower right vertex of the target area is the maximum value of the ordinate, to determine whether the target area is located at a certain corner point of the video image.

At step 72, when the target area is located at the vertex of the first video image, the server may acquire at least one target pixel, located within the first video image, in the target area. In other words, the server may acquire the target pixel in that portion, within the first video image, of the target area.

At step 73, the server may acquire a first distance between the at least one target pixel and the boundary of the first video image, where the first distance from the target pixel to the boundary of the first video image may be converted into a distance from a point to a line in mathematics, which may specifically refer to relevant technologies, and will not be repeated herein.

At step 74, when the first distance is less than a preset distance threshold, the server may determine that the target area being not tracked down in the corresponding video image is a type that the target area has been offset out of the video image (the target area has been offset out of the first video image), and assign the coordinate data of the target area to a null value. Where, a range of the above preset distance threshold may be 5˜20 pixels, and in an example, the value of the above preset distance threshold is 10 pixels. Since the coordinate data of the target area is forcibly assigned to the null value, it may be determined that the target area has been offset out of the boundary when the null value is subsequently read.

In another embodiment, in the first situation, the server may determine whether the target area is out of bounds (from the boundary of the first video image), as seen in FIG. 12, including step 81 to step 83.

At step 81, the server may determine whether each of vertexes of the target area in the first video image is located at the boundary of the first video image, where the first video image refers to the previous video image before the video image in which the target area is not tracked down. For example, the server may acquire whether each of the vertexes of the target area in the first video image is located at the boundary of the first video image (that is, the boundary). It can be understood that to determine whether a certain vertex of the target area is located at the boundary of the first video image, the server may determine whether the abscissa of the upper left vertex of the target area is 0, and whether the abscissa x of the lower left vertex of the target area is 0, to determine whether the target area is located at a left boundary of the first video image. For another example, the server may determine whether the ordinate of the upper left vertex of the target area is 0) and whether the ordinate of the upper right vertex of the target area is 0), to determine whether the target area is located at an upper boundary of the first video image. For another example, the server may determine whether the abscissa of the upper right vertex of the target area is the maximum value of the abscissa, and whether the abscissa of the lower right vertex of the target area is the maximum value of the abscissa, to determine whether the target area is located at a right boundary of the first video image. For another example, the server may determine whether the ordinate of the lower left vertex of the target area is the maximum value of the ordinate, and whether the ordinate of the lower right vertex of the target area is the maximum value of the ordinate, to determine whether the target area is located at a lower boundary of the first video image.

At step 82, when the target area is located at the boundary of the first video image, the server may acquire a second distance between a vertex, away from the boundary, in the target area and the boundary. When the server determines that the target area is located at a certain boundary of the first video image, the server may acquire the second distance between the vertex away from the boundary and the boundary, where calculation of the second distance may refer to calculation of a distance from a point to a side in mathematics, which will not be repeated herein.

At step 83, when the second distance is less than the preset distance threshold, the server may determine that the target area being not tracked down in the corresponding video image is a type that the target area has been offset out of the video image (the target area has been offset out of the first video image), and assign the coordinate data of the target area to a null value. The preset distance threshold may refer to the content of the embodiment shown in FIG. 11.

In this embodiment, by determining that the target area has been offset out of the video image, it may be determined that the area tracking model can work normally to ensure accuracy of a detection result.

For the situation that the target area has not been offset out of the video image, i.e., the second situation, the server may determine whether a search is to be re-performed.

In an embodiment, the reason that the target area is not matched may be that the tracking matching threshold is relatively large, so no matched target area is found, at this time, the server may reduce the tracking matching threshold. Assuming that the range of the tracking matching threshold is 0.3˜0.9, and when determining that the target area is not matched, a current tracking matching threshold is 0.6, and then the server may reduce the tracking matching threshold according to a preset step size (such as 0.1), then re-perform the step 12, i.e., the step of tracking the position of the target area in each of the subsequent video images according to the initial coordinate data and each of the subsequent video images to obtain the recognition result, and then determine whether there is the target area in the video image: if there is no target area in the video image, continue reducing the tracking matching threshold, and repeat this process until determining that the target area is tracked down in the corresponding video image or the tracking matching threshold is equal to a first probability threshold. Where, the first probability threshold refers to a minimum value of the tracking matching threshold, that is, a minimum reference value that the above area tracking model outputs a trusted or valid recognition result, for candidate area.

In another embodiment, considering that the area of the first video image being 4 times the area of the reference image may be relatively small, and then there is a certain probability that the target area cannot be found, a search range may be updated in this embodiment. For example, the server may generate a plurality of second tracked images, such as 2˜4, by taking each of the vertexes of the first tracked image corresponding to the corresponding video image as a center and by taking a length and width of the first tracked image as the basis, and perform a step of inputting the reference image and one of the second tracked images to the preset area tracking model. Thus, the number of the second tracked images in this embodiment is much greater than the number of the first tracked images, which may increase the search range of the target area, thereby increasing the probability of finding the target area. It is to be noted that when the above two situations that the target area is not tracked down are solved according to the above multiple solutions, if the target area of the current video image still cannot be tracked down, the server may adopt the target area of the previous video image as the target area of the current video image, so as to avoid a problem of mistakenly tracking, which is beneficial to improving accuracy of a tracking result.

It can be understood that in embodiments of the present disclosure, by determining whether the target area has been offset out of the video image or whether the area tracking model is abnormal, it is ensured that the method for updating a position of an area provided in the present disclosure can work reliably, and the accuracy of tracking the target area is ensured.

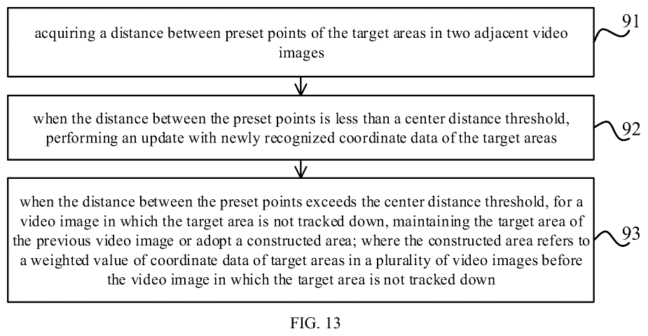

In an embodiment, after determining that the target area is tracked down in each of the video images, the server may determine whether there is mistakenly tracking, as seen in FIG. 13, including step 91 to step 93.

At step 91, the server may acquire a distance between preset points of the target areas in two adjacent video images. Where, the preset points may be set according to the target areas, such as vertexes, center points, centers of gravity, etc., of the target areas, which is not limited herein. For example, when the target areas are regular graphics, for example, the regular graphics are rectangles, the preset points may be the center points. When the target areas are irregular graphics, each of the preset points may be one of the vertices of each of the target areas. The distance between the two preset points may be converted into a Euclidean distance between two points in mathematics, which may specifically refer to a calculation manner of the Euclidean distance in relevant technologies, and will not be repeated herein.

At step 92, when the distance between the preset points is less than a center distance threshold, the server may perform an update with newly recognized coordinate data of the target areas. Where, the range of the center distance threshold is 1˜10 pixels. In an example, the above center distance threshold is 5 pixels. When the distance between the preset points is less than the center distance threshold, the server may determine that the target areas in the video image is not mistakenly tracked, and the server may adopt the latest target coordinate data for the target areas of the video images.

It is to be noted that the above center distance threshold is related to a collection frequency of the camera, and the higher the collection frequency of the camera is, the smaller the center distance threshold is. For example, when the collection frequency of the camera is 25 Hz, the center distance threshold may be set to 10 pixels, and when the collection frequency of the camera is 50 Hz, the center distance threshold may be set to 5 pixels. Technicians may set the center distance threshold according to specific scenarios, which is not limited herein.

At step 93, when the distance between the preset points exceeds the center distance threshold, for a video image in which the target area is not tracked down, the server may maintain the target area of the previous video image or adopt a constructed area. The constructed area refers to a weighted value of coordinate data of target areas in a plurality of video images before the video image in which the target area is not tracked down. For example, the server may record the offsets of the target area in the x, y direction at least 5 times, where five historical offsets of the restricted area in the x-direction are [1, 2, −1, 0, 1], and five historical offsets of the restricted area in the y direction are [1, 1, −1, 1, 0]: then, the offset of the target area in the current video image relative to the previous video image is predicted by taking an average, that is, the offset of the target area of the current video image is [1, 0] (a rounded result of [0.6, 0.4]), and then combined with the coordinate data of the reference image, the target coordinate data of the target area in the current video image may be obtained.

At step 14, in response to determining that the pose of the camera has changed, the initial coordinate data is updated according to the target coordinate data, to update the position of the target area in each of the subsequent video images.

In this embodiment, after determining the target area and target coordinate data thereof in each of the video images, the server may determine whether the pose of the camera has changed. For example, the server may acquire an angle change of the camera, and the server may determine that the pose of the camera has changed, when the angle change meets a preset condition. The server may communicate with the camera to obtain a movement and/or rotation angle change of the camera, and determine the angle change through the movement and/or rotation angle change. For example, when the movement and/or rotation angle change is 0, the server determines that the camera is in a stationary state: when the movement and/or rotation angle change is a certain value not equal to 0), the server determines that the pose of the camera has changed. Where, the above preset condition refers to that the camera goes from stationary to mobile and to stationary again, and stays stationary for a certain duration (such as 30˜100 seconds), or the angle change exceeds a preset angle threshold (e.g., 5 degrees).

For another example, the server may acquire distances between a same pixel in target areas in two adjacent video images. Then, the server may compare the distances between the respective pixels with a preset pixel distance threshold: if the server obtains at least one, of the distances between the respective pixels, that exceeds the pixel distance threshold, the server may determine that the pose of the camera has changed; and if the distances between the respective pixels are all less than the pixel distance threshold, the server may determine that the pose of the camera has not changed.

For another example, the server may acquire a distance between the preset points of the target areas in two adjacent video images. When the distance between the preset points exceeds a center threshold, the server may determine that the pose of the camera has changed; and when the distance between the preset points is less than the center threshold, the server may determine that the pose of the camera has not changed.

In this embodiment, after determining that the pose of the camera has changed, the server may update the initial coordinate data according to the target coordinate data. For example, when the shape of each of the target areas is a rectangle, the server may update the initial coordinate data to the target coordinate data. For another example, when the shape of each of the target areas is another shape other than the rectangle, the server may acquire the relative position data of the preset target area relative to the minimum bounding rectangle, where the manner of acquiring the relative position data of the above preset target area relative to the minimum bounding rectangle refers to step 11 and the content of the examples shown in FIG. 2 and FIG. 3, which will not be repeated herein. Then, the server may calculate target recovery data of the target area according to the target coordinate data and the relative position data; and update the initial coordinate data to the above target recovery data.

In other words, the server may re-obtain initial coordinate data by updating the initial coordinate data, and re-perform step 11 to step 14 to update the position of the target area in each of the video images.

So far in this embodiment, the target areas in the video image remains unchanged when the camera does not move and/or rotate, and the coordinate data of the target areas will be updated after the camera moves and/or rotates to the target coordinate data, that is, the positions of the target areas are synchronously updated after the camera rotates, so that the target areas will not be mispositioned with the movement and/or rotation of the camera, and then there will be no problem of misrecognition and false alerts during the subsequent process of recognition of objects in the target areas, which is beneficial to improving the recognition efficiency, and further improving the usage experience.

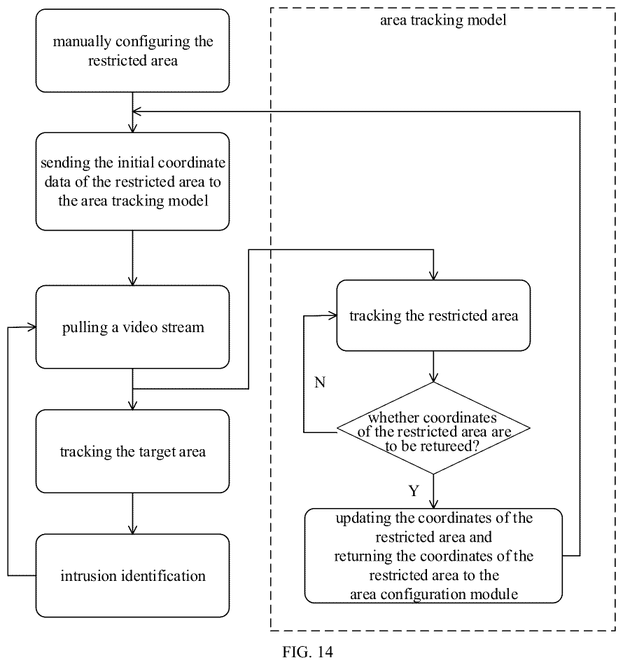

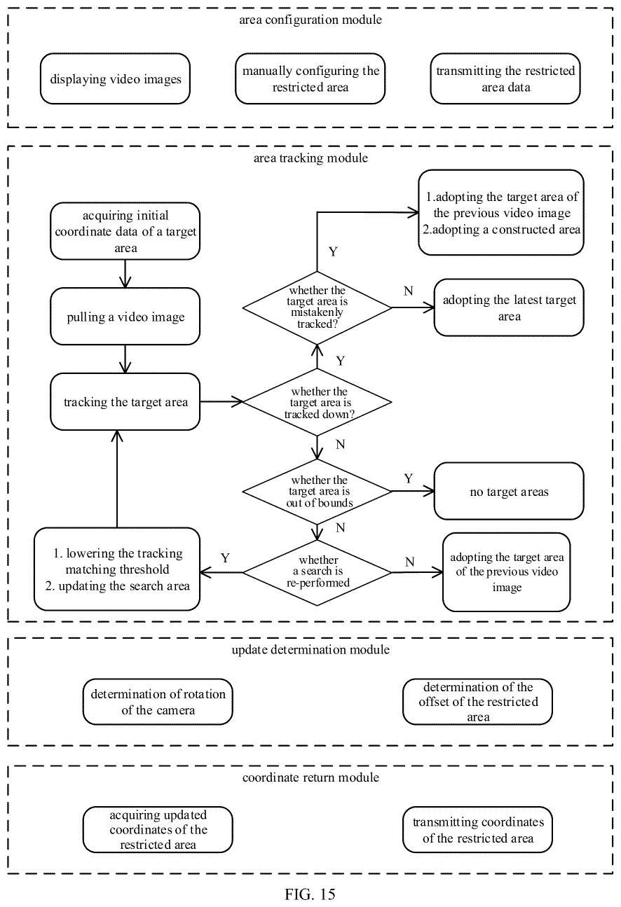

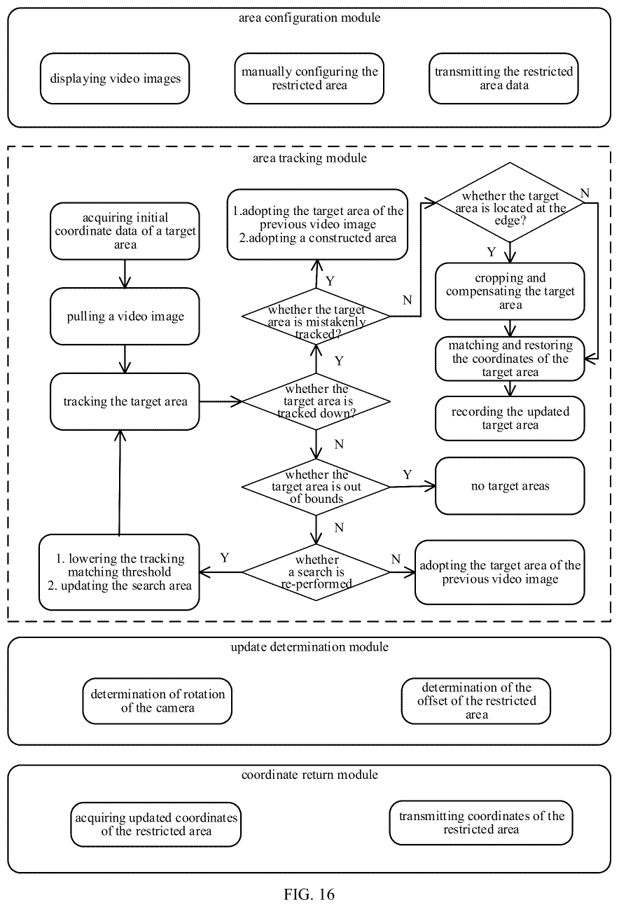

The method for updating a position of an area provided by the embodiments of the present disclosure is described below in conjunction with a restricted area intrusion identification scenario, with the restricted area as the above target area. As seen in FIG. 14 to FIG. 16, a security system provided by the embodiments of the present disclosure may include an area configuration module, an area tracking module, an update determination module, and a coordinate return module.

The area configuration module may: display video images, manually configure the restricted area, automatically receive coordinates of the restricted area sent by the coordinate return module, and send the coordinates of the restricted area to the area tracking module.

### Area Configuration Module

A webpage in the area configuration module may display a video image from the camera to be configured. In a practical application, as seen in FIG. 4, the webpage may include three interactive operation buttons: a brush component 21, an eraser component 22, and a save component 23. The user may click the brush component 21 to draw the restricted area point by point, and may also use the eraser component 22 to erase the vertices that have been drawn during the drawing process. After the drawing is completed, the user may click the save component 23 to obtain coordinate data of all vertices of the restricted area, that is, the initial coordinate data in the above embodiments, which may specifically refer to content of step 11 of the example shown in FIG. 1. The area configuration module may send the coordinates of the restricted area to the area tracking module. In this way, an operation of manually configuring the restricted area is completed.

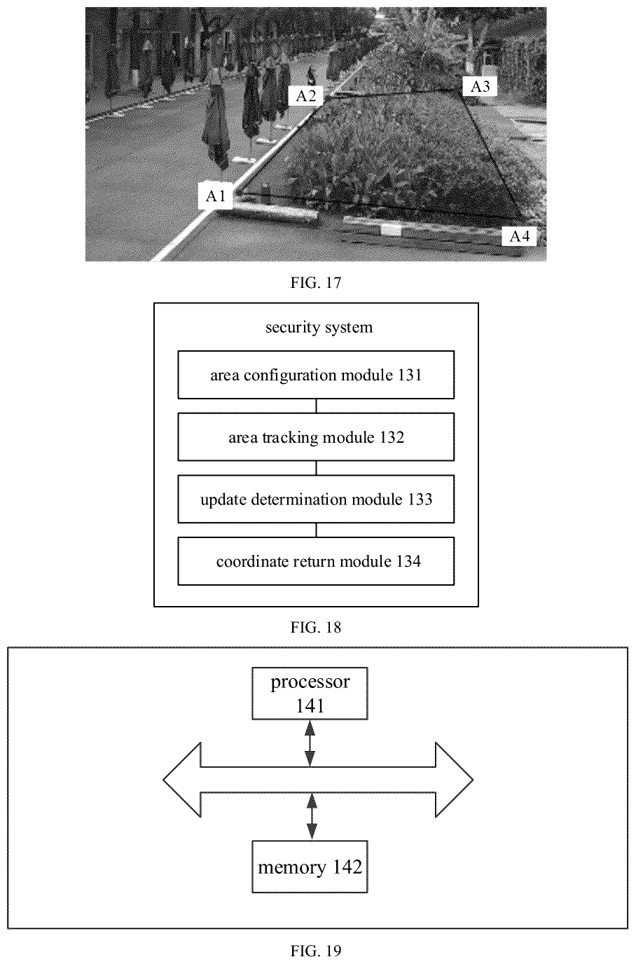

In addition, the area configuration module may wait in real time to receive latest coordinates of the restricted area, that is, the target coordinate data, sent by the coordinate return module. When the target coordinate data is received, the area configuration module may update the initial coordinate data of the restricted area to the above target coordinate data, and send the updated initial coordinate data to the area tracking module. At the same time, the restricted area is redrawn in the displayed video image based on the updated coordinate data, as shown by the restricted area A1A2A3A4 in FIG. 17.

### Area Tracking Module

A working process of the area tracking module may refer to content of the examples shown in FIG. 8 and FIG. 9. In addition, the area tracking module uses a tracking method based on depth features, to track the above restricted area by using the coordinate data of the restricted area sent by the area configuration module and the pulled video stream.

A specific process of restricted area tracking includes the following.

First, the area tracking module acquires the coordinates of the restricted area from the area configuration module and acquires the latest video image, that is, the above target image.

Then, the area tracking module takes content in a restricted area box in the latest video image as a template, that is, the above reference image, and extracts features of the template; and feeds, into the siamese network, content (that is, the above first tracked image) in an area four times the size of the template, in each of video images after the latest video image and the template. Then, the siamese network feeds the extracted features into the classification branch and regression branch of the region proposal network RPN respectively. The classification branch outputs the probability that each area belongs to the classification, background or target (that is, the content within the restricted area), and the regression branch outputs prediction values (i.e., the above target coordinate data) of the offsets [x, y, w, h] of each area.

Finally, the area tracking module may take an area with a maximum probability value as the restricted area that is tracked down; and if the probability values of all areas are less than the preset probability threshold, the area tracking module may determine that there is no restricted area in this video image.

### Tracking Stability Mechanism

The area tracking model cannot ensure that the restricted area can be accurately tracked in all situations, for example, when there are abnormal situations, such as the severely blurred video images or the flickering screens, the area tracking model will fail. The present disclosure also provides a tracking stability mechanism to ensure that the restricted area is tracked normally in the situation of an abnormal area tracking model, which may improve the tracking stability.

First, it is determined whether the area tracking model tracks down the restricted area. If the area tracking model does not track down the restricted area, there are two situations: the area tracking model is normal and the restricted area has been offset out of the video image: the restricted area has not been offset out of the boundary of the video image and the area tracking model is abnormal. Specific principles of the tracking stability mechanism include the following.

It is determined whether the restricted area in the previous video image is located at the upper left corner/upper right corner/lower left corner/lower right corner of the video image. It is determined whether the restricted area is located at the upper left corner of the video image by determining: whether coordinates at the upper left corner of the restricted area are [0, 0]; whether the abscissa x at the lower left corner of the restricted area is 0; and whether the y coordinate at the upper right corner of the restricted area is 0. The other corner points are determined in this way adaptively. If the restricted area is located at a corner point, it is determined whether a distance from a pixel, not located at the boundary of the video image, in the restricted area to the boundary of the video image is less than 10 pixels, and if the distance is less than 10 pixels, it is determined that the restricted area has been offset out of the video image.

It is determined whether the restricted area in the previous video image is located at the boundary of the video image. It is determined whether the restricted area is located at the left boundary of the video image by determining: whether the abscissa x at the upper left corner of the restricted area is 0; and whether the abscissa x at the lower left corner of the restricted area is 0). The other boundaries are determined in this way adaptively. If the restricted area is located at the boundary of the video image, it is determined whether the distances from the other two vertices, not located at the boundary of the video image, of the restricted area to the boundary of the video image are less than 10 pixels, and if the distances are less than 10 pixels, it is determined that the restricted area has been offset out of the video image.

For the situation that the restricted area has been offset out of the video image, it is directly determined that there is no restricted area in the current video image, and restricted area information in the current video image is assigned to the null value.

For the situation that the restricted area has not been offset out of the video image, it is to determine whether a search is to be re-performed. Embodiments of the present disclosure provide two methods of re-performing a search as follows.

1. The tracking matching threshold is lowered. It has been determined that the restricted area is in the video image but the restricted area is not found, which may be that the tracking matching threshold is set relatively high causing no restricted area found. At this point, the tracking matching threshold in the area tracking model may be lowered and a search may be re-performed. It is assumed that the current tracking matching threshold is 0.6, the minimum value of the tracking matching threshold is 0.3, and the preset step size is 0.1. If it is to lower the tracking matching threshold, the tracking matching threshold is lowered by 0.1 and the determination is re-performed in the area tracking model. If the restricted area is not tracked down, the tracking matching threshold is lowered again and the determination is re-performed, until the minimum value of the tracking matching threshold is reached or the restricted area is tracked down.

2. The search area is changed. Because the search area for the area tracking model is an area whose length and width is twice the length and width of an area where a current template is located, resulting in a probability that the restricted area cannot be found. At this time, the search area may be changed to re-perform a search, including the following.

Four vertices of the current search area (i.e., the above first tracked image) are taken as the centers, and the length and width of the current search area are inherited, so that four new search areas may be constructed to obtain the above second tracked images: then, the above four second tracked images are fed into the area tracking model at a time, and the restricted area is re-tracked.

If the restricted area of the current video image cannot be still found in the above two manners, the restricted area of the current video image maintains the restricted area of the previous video image, that is, the coordinate data of the restricted area of the current video image uses the coordinate data of the restricted area of the previous video image, so as to avoid a problem of an inaccurate tracking result caused by an inaccurate area tracking model, which is beneficial to improving the accuracy of the tracking result.

Then, determining whether there is mistakenly tracking for the tracking result, includes the following.

It is determined whether the distance between the preset point of the restricted area of the current video image and the preset point of the restricted area of the previous video image is greater than a preset point threshold (such as 5 pixels), and if the distance is less than the preset point threshold, it can be determined that there is no mistakenly tracking. Then, it is determined whether the target area is located at the edge of the current video image, when the target area is located at the edge of the current video image, the restricted area is cropped and compensated (such as complementing the edge, so that the portion located in the current video image forms an enclosed area), and the coordinates of the restricted area are matched and recovered, that is, the latest coordinate data may be used. If the distance is greater than the preset point threshold, it is determined that there is the mistakenly tracking. A manner of handling the mistakenly tracking may include the following.

1. The restricted area of the previous video image is maintained.

2. The constructed area is adopted. For example, the offsets of five historical restricted areas in the x and y directions are acquired, and the offset of the restricted area of the current video image relative to the restricted area in the previous video image is predicted in the manner of taking the average. For example, the offsets in the x direction are [1, 2, −1, 0). 1], and the offsets in the y direction are [1, 1, −1, 1, 0]: therefore, the offset of the target area in the current video image is [0.6, 0.4], and then [1, 0] is obtained after rounding.

### Update Determination Module

The area tracking module obtains the coordinate data of the restricted area in each of the video images. The area tracking model is to real-time process, and a position of a target box of the restricted area will be predicted for each of the video images, but not the coordinate data of the restricted area of each of the video images is to be returned to the area configuration module. Then, the manner of the area tracking module determining the returned coordinate data includes the following.

1. It is determined whether the coordinates of the restricted area are to be returned by determining the movement and/or rotation state of the camera. The update determination module acquires the movement and/or rotation angle of the camera in real time, and when determining that the camera has changed from the movement and/or rotation state to the stationary state for a set duration, it may be determined that the camera has moved and/or rotated once, and then the coordinate data of the restricted area is to be updated. In addition, to improve the accuracy of this manner, timing update of the coordinates may also be set in this manner, such as forcibly updating the coordinate data of the restricted area every hour.

2. It is determined whether the coordinates of the restricted area are to be returned by determining a relative position change of coordinates of the restricted area box in the image. If the camera moves and/or rotates, there will be a deviation between the target coordinate data and the initial coordinate data of the restricted area, so by comparing the deviation between the coordinates of the restricted area, it can be determined whether the camera moves and/or rotates, including: comparing respective pixels in the two restricted areas pixel by pixel, and determining that the pose of the camera has changed when one of distances between the respective pixels exceeds the pixel distance threshold (such as 5 pixels). Or, the distance between the preset points in the two restricted area is calculated, and if the distance between the preset points exceeds the center threshold, it can be determined that the pose of the camera has changed.

### Coordinate Return Module

When the update determination module determines that the coordinates of the restricted area are to be returned (that is, to return the target coordinate data of the restricted area), the coordinate return module acquires the target coordinate data of the restricted area in the current video image and sends the target coordinate data to the area configuration module.

After receiving the target coordinate data, the area configuration module may update the value of the initial coordinate data to the value of the above target coordinate data, update the restricted area in a display interface, and send the updated coordinates of the restricted area to the area tracking module. At this point, an automatic update of the coordinates of the restricted area is completed once.

On the basis of a method for updating a position of an area provided by the embodiments of the present disclosure, the embodiments of the present disclosure also provide a security system. As seen in FIG. 18, the system includes: an area configuration module 131, an area tracking module 132, an update determination module 133, and a coordinate return module 134.

The area configuration module 131 is configured to acquire initial coordinate data of a target area in a video image, and send the initial coordinate data to the area tracking module.

The area tracking module 132 is configured to track a position of the target area in each of subsequent video images according to the initial coordinate data and each of the subsequent video images to obtain a recognition result, and when the recognition result contains target coordinate data, send the target coordinate data to the update determination module.

The update determination module 133 is configured to determine whether a pose of a camera has changed, and in response to determining that the pose of the camera has changed, send the target coordinate data to the coordinate return module 134.

The coordinate return module 134 is configured to return the target coordinate data to the area configuration module 131, so that the area configuration module 131 updates the initial coordinate data according to the target coordinate data, to update the position of the target area in each of the video images.

In an embodiment, the area tracking module being configured to track the position of the target area in each of the subsequent video images according to the initial coordinate data and each of the subsequent video images to obtain the recognition result, includes:
based on the initial coordinate data, acquiring an image of a target area corresponding to the initial coordinate data in a target video image, to obtain a reference image;
based on the initial coordinate data, acquiring an image, containing the target area, in each of video images after the target video image, to obtain a first tracked image corresponding to each of the video images;
inputting the reference image and one of the first tracked images to a preset area tracking model to obtain the recognition result output by the area tracking model, where the recognition result includes one or more probability values and coordinate data of at least one candidate area in a corresponding video image.

In an embodiment, the area tracking module being configured to, when the recognition result contains the target coordinate data, send the target coordinate data to the update determination module, includes:
acquiring a maximum value of the one or more probability values of the at least one candidate area;
when the maximum value exceeds a preset probability threshold, determining a candidate area corresponding to the maximum value as the target area tracked down in the corresponding video image, and obtaining the target coordinate data of the target area; and
sending the target coordinate data of the target area to the update determination module.

In an embodiment, the area tracking module is further configured to:
when the maximum value is less than the preset probability threshold, determine that the target area is not tracked down in the corresponding video image.

In an embodiment, the area tracking module being configured to determine that the target area is not tracked down in the corresponding video image, includes:
determining whether a target area in the first video image is located at the vertexes of the first video image, where the first video image refers to a previous video image before a video image in which the target area is not tracked down;
when the target area is located at the vertexes of the first video image, acquiring at least one target pixel, located within the first video image, in the target area;
acquiring a first distance between the at least one target pixel and the boundary of the first video image; and
when the first distance is less than a preset distance threshold, determining that the target area being not tracked down in the corresponding video image is a type that the target area has been offset out of the video image, and assigning the coordinate data of the target area to a null value.

In an embodiment, the area tracking module being configured to determine that the target area is not tracked down in the corresponding video image, includes:
determining whether each of vertexes of a target area in a first video image is located at a boundary of the first video image, where the first video image refers to a previous video image before a video image in which the target area is not tracked down;
when the target area is located at the boundary of the first video image, acquiring a second distance between a vertex, away from the boundary, in the target area and the boundary; and
when the second distance is less than a preset distance threshold, determining that the target area being not tracked down in the corresponding video image is a type that the target area has been offset out of the video image, and assigning the coordinate data of the target area to a null value.

In an embodiment, when the target area being not tracked down is that the area tracking model is abnormal and the restricted area is located within a first video image, after the area tracking module is configured to determine that the target area is not tracked down in each of the video images, the area tracking module is further configured to:
reduce a tracking matching threshold according to a preset step size, and perform the step of tracking the position of the target area in each of the subsequent video images according to the initial coordinate data and each of the subsequent video images to obtain the recognition result, until determining that the target area is tracked down in the corresponding video image or the tracking matching threshold is equal to a first probability threshold.

In an embodiment, when the target area being not tracked down is that the area tracking model is abnormal and the restricted area is located within a first video image, after the area tracking module is configured to determine that the target area is not tracked down in each of the video images, the area tracking module is further configured to:
generate a plurality of second tracked images by taking each of vertexes of a first tracked image corresponding to the corresponding video image as a center and by taking a length and width of the first tracked image as a reference, and perform a step of inputting the reference image and one of the second tracked images to the preset area tracking model.

In an embodiment, the area tracking module is further configured to:
acquire a distance between preset points of the target area in two adjacent video images;
when the distance between the preset points is less than a center distance threshold, perform an update with newly recognized coordinate data of the target area; and
when the distance between the preset points exceeds the center distance threshold, for a video image in which the target area is not tracked down, maintain a target area of a previous video image or adopting a constructed area, where the constructed area refers to a weighted value of coordinate data of the target area in a plurality of video images before the video image in which the target area is not tracked down.

In an embodiment, the update determination module being configured to determine whether the pose of the camera has changed, includes:
acquiring an angle change of the camera; and
when the angle change meets a preset condition, determining that the pose of the camera has changed.

In an embodiment, the update determination module being configured to determine whether the pose of the camera has changed, includes:
acquiring distances between a same pixel in the target area in two adjacent video images; and
when at least one of the distances between the respective pixels exceeds a pixel distance threshold, determining that the pose of the camera has changed.

In an embodiment, the update determination module being configured to determine whether the pose of the camera has changed, includes:
acquiring a distance between preset points of the target area in two adjacent video images; and
when the distance between the preset points exceeds a center threshold, determining that the pose of the camera has changed.

It is to be noted that the apparatus shown in the present embodiment matches the content of the method embodiment, and may refer to the content of the above method embodiment, which will not be repeated herein.

A security system is also provided in the exemplary embodiments. The security system includes at least one camera, at least one configuration terminal, and a server. The camera is configured to collect an image and send the image to the server: the configuration terminal is configured to acquire initial coordinate data of a target area and send the initial coordinate data to the server. As seen in FIG. 19, the server includes:
a processor 141; and a memory 142 configured to store a computer program executable by the processor;
where the processor is configured to execute the computer program stored in the memory, to implement the method as described in FIG. 1 to FIG. 17.

In an exemplary embodiment, a non-transitory computer-readable storage medium is also provided, for example, a memory including an executable computer program. The above executable computer program may be executed by a processor, to implement the method in the embodiments shown in FIG. 1 to FIG. 12. Where, the readable storage medium may be a Read-Only Memory (ROM), a Random Access Memory (RAM), a Compact Disc Read-Only Memory CD-ROM, a magnetic tape, a floppy disk, an optical data storage device, and so on.

After considering the specification and practice of the present disclosure, the skilled in the art will easily conceive of other implementations of the present disclosure. The present disclosure is intended to cover any variations, uses, and adaptive changes of the present disclosure that follow general principles of the present disclosure and include common knowledge or conventional technical means in the art that are not disclosed in the present disclosure. The specification and embodiments are only considered exemplary and the real scope and spirit of the present disclosure are indicated by the following claims.

It is to be understood that the present disclosure is not limited to precise structures, described above and shown in the accompanying drawings, and may be modified or changed variously without departing from the scope of the present disclosure. The scope of the present disclosure is limited only by the appended claims.

1. A method for updating a position of an area, comprising:
acquiring initial coordinate data of a target area in a video image;
tracking a position of the target area in each of subsequent video images according to the initial coordinate data and each of the subsequent video images to obtain a recognition result;
when the recognition result comprises target coordinate data, determining whether a pose of a camera has changed; and
in response to determining that the pose of the camera has changed, updating the initial coordinate data according to the target coordinate data, to update the position of the target area in each of the subsequent video images.

2. The method of claim 1, wherein acquiring the initial coordinate data of the target area in the video image, comprises:
in response to detecting an operation indicating drawing of the target area, acquiring coordinate data of each of triggering positions;
connecting each of the triggering positions in sequence to obtain the target area; and
when a shape of the target area is a rectangle, using the coordinate data of each of the triggering positions as the initial coordinate data of the target area: when the shape of the target area is another shape other than the rectangle, acquiring a minimum bounding rectangle of the another shape, and using coordinate data of each of vertexes of the minimum bounding rectangle as the initial coordinate data of the target area.

3. The method of claim 1, wherein tracking the position of the target area in each of the subsequent video images according to the initial coordinate data and each of the subsequent video images to obtain the recognition result, comprises:
acquiring, based on the initial coordinate data, an image of a target area corresponding to the initial coordinate data in a target video image, to obtain a reference image: wherein the target video image refers to a first frame of video image obtained after acquiring the initial coordinate data;
acquiring first tracked images based on the initial coordinate data, wherein each of the first tracked images refers to an image, comprising the target area, in each of video images after the target video image; and
inputting the reference image and one of the first tracked images to a preset area tracking model to obtain the recognition result, wherein the recognition result comprises one or more probability values and coordinate data of at least one candidate area in a corresponding video image.

4. The method of claim 3, wherein the area tracking model comprises a siamese network module, a region proposal network module, and a recognition result module:
the siamese network module comprises an upper branch network and a lower branch network: the upper branch network and the lower branch network have a same network structure and same parameters: the upper branch network outputs a feature image with a first size, and the lower branch network outputs a feature image with a second size;
the region proposal network module comprises a classification branch network and a regression branch network; the classification branch network is configured to distinguish a target and a background according to the feature image with the first size and the feature image with the second size: the regression branch network is configured to adjust a position of each of the at least one candidate area; and
the recognition result module comprises a class output unit and a coordinate data output unit: the class output unit is connected to the classification branch network, and configured to output the probability value of each of the at least one candidate area: the coordinate data output unit is connected to the regression branch network, and configured to output the coordinate data of each of the at least one candidate area.

5. The method of claim 3, further comprising: a step of determining whether the recognition result comprises the target coordinate data: wherein the step specifically comprises:
acquiring a maximum value of the one or more probability values of the at least one candidate area; and
when the maximum value exceeds a preset probability threshold, determining a candidate area corresponding to the maximum value as the target area tracked down in the corresponding video image, and obtaining the target coordinate data of the target area.

6. The method of claim 5, further comprising:
when the maximum value is less than the preset probability threshold, determining that the target area is not tracked down or a portion of the target area is tracked down in the corresponding video image.

7. The method of claim 6, wherein determining that the target area is not tracked down in the corresponding video image, comprises:
determining whether a target area in a first video image is located at a boundary of the first video image, wherein the first video image refers to a previous video image before a video image in which the target area is not tracked down;
when the target area is located at the boundary of the first video image, acquiring a second distance between a vertex, away from the boundary, in the target area and the boundary; and
when the second distance is less than a preset distance threshold, determining that the target area being not tracked down in the corresponding video image is a type that the target area has been offset out of the video image.

8. The method of claim 6, wherein when the target area being not tracked down is that the area tracking model is abnormal and the target area is within a first video image, the method further comprises:
reducing a tracking matching threshold according to a preset step size, and performing the step of tracking the position of the target area in each of the subsequent video images according to the initial coordinate data and each of the subsequent video images to obtain the recognition result, until determining that the target area is tracked down in the corresponding video image or the tracking matching threshold is equal to a first probability threshold, wherein the first probability threshold refers to a minimum value of the tracking matching threshold.

9. The method of claim 6, wherein when the target area being not tracked down is that the area tracking model is abnormal and the target area is within a first video image, the method further comprises:
generating a plurality of second tracked images by taking each of vertexes of a first tracked image corresponding to the corresponding video image as a center and by taking a length and width of the first tracked image as a reference, and performing a step of inputting the reference image and one of the second tracked images to the preset area tracking model.

10. The method of claim 6, wherein the method further comprises:
acquiring a distance between preset points of the target area in two adjacent video images;
when the distance between the preset points is less than a center distance threshold, performing an update with newly recognized coordinate data of the target area; and
when the distance between the preset points exceeds the center distance threshold, for a video image in which the target area is not tracked down, maintaining a target area of a previous video image or adopting a constructed area, wherein the constructed area refers to a weighted value of coordinate data of the target area in a plurality of video images before the video image in which the target area is not tracked down.

11. The method of claim 1, wherein determining whether the pose of the camera has changed, comprises:
acquiring an angle change of the camera; and
when the angle change meets a preset condition, determining that the pose of the camera has changed.

12. The method of claim 1, wherein determining whether the pose of the camera has changed, comprises:
acquiring distances between a same pixel in the target area in two adjacent video images; and
when at least one of the distances between the respective pixels exceeds a pixel distance threshold, determining that the pose of the camera has changed.

13. The method of claim 1, wherein determining whether the pose of the camera has changed, comprises:
acquiring a distance between preset points of the target area in two adjacent video images; and
when the distance between the preset points exceeds a center threshold, determining that the pose of the camera has changed.

14. The method of claim 1, wherein updating the initial coordinate data according to the target coordinate data, comprises:
when a shape of the target area is a rectangle, updating the initial coordinate data to the target coordinate data; or
when the shape of the target area is another shape other than the rectangle, acquiring relative position data of a preset target area relative to a minimum bounding rectangle; calculating target recovery data of the target area according to the target coordinate data and the relative position data; and updating the initial coordinate data to the target recovery data.

15-28. (canceled)

29. A security system, comprising at least one camera, at least one configuration terminal, and a server; wherein the camera is configured to collect an image and send the image to the server: the configuration terminal is configured to acquire initial coordinate data of a target area and send the initial coordinate data to the server:
the server comprises:
a processor; and
a memory configured to store a computer program executable by the processor;
wherein the processor is configured to execute the computer program stored in the memory, to:
acquire initial coordinate data of a target area in a video image;
track a position of the target area in each of subsequent video images according to the initial coordinate data and each of the subsequent video images to obtain a recognition result;
when the recognition result comprises target coordinate data, determine whether a pose of a camera has changed; and
in response to determining that the pose of the camera has changed, update the initial coordinate data according to the target coordinate data, to update the position of the target area in each of the subsequent video images.

30. A non-transitory computer-readable storage medium, wherein an executable computer program in the storage medium, when executed by a processor, can:
acquire initial coordinate data of a target area in a video image;
track a position of the target area in each of subsequent video images according to the initial coordinate data and each of the subsequent video images to obtain a recognition result;
when the recognition result comprises target coordinate data, determine whether a pose of a camera has changed; and
in response to determining that the pose of the camera has changed, update the initial coordinate data according to the target coordinate data, to update the position of the target area in each of the subsequent video images.

31. The method of claim 2, wherein tracking the position of the target area in each of the subsequent video images according to the initial coordinate data and each of the subsequent video images to obtain the recognition result, comprises:
acquiring, based on the initial coordinate data, an image of a target area corresponding to the initial coordinate data in a target video image, to obtain a reference image: wherein the target video image refers to a first frame of video image obtained after acquiring the initial coordinate data;
acquiring first tracked images based on the initial coordinate data, wherein each of the first tracked images refers to an image, comprising the target area, in each of video images after the target video image; and
inputting the reference image and one of the first tracked images to a preset area tracking model to obtain the recognition result, wherein the recognition result comprises one or more probability values and coordinate data of at least one candidate area in a corresponding video image.

32. The method of claim 7, wherein the method further comprises:
acquiring a distance between preset points of the target area in two adjacent video images;
when the distance between the preset points is less than a center distance threshold, performing an update with newly recognized coordinate data of the target area; and
when the distance between the preset points exceeds the center distance threshold, for a video image in which the target area is not tracked down, maintaining a target area of a previous video image or adopting a constructed area, wherein the constructed area refers to a weighted value of coordinate data of the target area in a plurality of video images before the video image in which the target area is not tracked down.

33. The method of claim 8, wherein the method further comprises:
acquiring a distance between preset points of the target area in two adjacent video images;
when the distance between the preset points is less than a center distance threshold, performing an update with newly recognized coordinate data of the target area; and
when the distance between the preset points exceeds the center distance threshold, for a video image in which the target area is not tracked down, maintaining a target area of a previous video image or adopting a constructed area, wherein the constructed area refers to a weighted value of coordinate data of the target area in a plurality of video images before the video image in which the target area is not tracked down.

34. The method of claim 9, wherein the method further comprises:
acquiring a distance between preset points of the target area in two adjacent video images;
when the distance between the preset points is less than a center distance threshold, performing an update with newly recognized coordinate data of the target area; and
when the distance between the preset points exceeds the center distance threshold, for a video image in which the target area is not tracked down, maintaining a target area of a previous video image or adopting a constructed area, wherein the constructed area refers to a weighted value of coordinate data of the target area in a plurality of video images before the video image in which the target area is not tracked down.
